(19) United States
(12) Patent Application Publication
(10) Pub. No.: US 2009/0022871 A1
(43) Pub. Date: Jan. 22, 2009

(54) Gelling Agent for Low Calorie Gels

(75) Inventors: Anders Boisen Thoegersen, Ronnede (DK); Steen Hojgaard Christensen, Bonshoj (DK)

Correspondence Address: J M HUBER CORPORATION, 333 THORNALL STREET, PATENT DEPARTMENT, EDISON, NJ, 08837-2220, US

(73) Assignee: CP KELCO APS, Lille Skensved, DK (DK)

(21) Appl. No.: 11/577,062

(22) PCT Filed: Oct. 12, 2005
(86) PCT No.: PCT/DK05/00653

§ 371 Date: Apr. 11, 2007

(30) Foreign Application Priority Data
Oct. 13, 2004 (DK) PA200401568

(51) Int. Cl. A23L 1/06; A23L 1/05

(52) U.S. Cl. 426/577

(57) ABSTRACT

A gelling system characterised in that it is a combination of a primary pectin and at least one secondary pectin. The primary pectin has a content of free acids (Degree of Free Acids, DFA) in the range of 50-80% and the combination comprises at least 5% by weight of said secondary pectin. The gelling system is suitable for gelation of low soluble solids products having SS % of less than about 30.

### CROSS-REFERENCE TO RELATED APPLICATION

This Application is a Section 371 filing of International Application No. PCT/DK2005/000653, filed 13 Oct. 2004, the disclosure of which is incorporated herein by reference.

### BACKGROUND OF THE INVENTION

In U.S. Pat. No. 5,929,051, Ni, et al. describes pectin as a plant cell wall component. The cell wall is divided into three layers, middle lamella, primary, and secondary cell wall. The middle lamella is the richest in pectin. Pectins are produced and deposited during cell wall growth. Pectin is particularly abundant in soft plant tissues under conditions of fast growth and high moisture content. In cell walls, pectin is present in the form of a calcium complex. The involvement of calcium cross-linking is substantiated by the fact that chelating agents facilitate the release of pectin from cell walls as disclosed by Nanji (U.S. Pat. No. 1,634,879) and Maclay (U.S. Pat. No. 2,375,376).

Pectin is a complex polysaccharide associated with plant cell walls. It consists of an alpha 1-4 linked polygalacturonic acid backbone intervened by rhamnose residues and modified with neutral sugar side chains and non-sugar components such as acetyl, methyl, and ferulic acid groups.

The neutral sugar side chains, which include arabinan and arabinogalactans, are attached to the rhamnose residues in the backbone. The rhamnose residues tend to cluster together on the backbone. So, with the side chains attached this region is referred to as the hairy region and the rest of the backbone is hence named the smooth region.

Pectin is traditionally used as food additives. However, its use has extended into pharmaceutical areas as well. Pectin has long been used as an anti-diarrhea agent and can improve intestinal functions. The anti-diarrhea effect is thought to be in part due to pectin's anti-microbial activity.

Pectin is also effective against gastrointestinal ulcers and enterocolitis. Pectin also influences cell proliferation in the intestines. It also has blood cholesterol lowering effect and exhibits inhibition of atherosclerosis. This effect is the result of interactions between pectin and bile salts. Pectin has also been shown to affect the fibrin network in hypercholesterolaemic individuals.

The ability to interact with many divalent metal ions renders pectin a strong detoxifying agent.

The resistance of pectin to degradation in the upper GI tract and its complete dissolution in the colon makes pectin very suited for colon-specific delivery. Coacervation with gelatine permits the formation of microglobules suitable for controlled-release products. Further, pectin is used in tablet formulations.

According to Dumitriu, S.: Polysaccharides, Structural diversity and functional versatility, Marcel Dekker, Inc., New York, 1998, 416-419, pectin is used in a range of food products.

Historically, pectin has mainly been used as a gelling agent for jam or similar, fruit-containing, or fruit-flavoured, sugar-rich systems. Examples are traditional jams, jams with reduced sugar content, clear jellies, fruit-flavoured confectionery gels, non-fruit-flavoured confectionery gels, heat-reversible glazings for the bakery industry, heat-resistant jams for the bakery industry, ripples for use in ice cream, and fruit preparations for yoghurt.

A substantial portion of pectin is today used for stabilization of low-pH milk drinks, including fermented drinks and mixtures of fruit juice and milk.

Lately, pectin has been found to be effective for the treatment of heartburn caused by esophagus acid reflux.

The galacturonic acid residues in pectin are partly esterified and pre-sent as the methyl ester. The degree of esterification is defined as the percentage of carboxyl groups esterified. Pectin with a degree of esterification (“DE”) above 50% is named high methyl ester (“HM”) pectin or high ester pectin and one with a DE lower than 50% is referred to as low methyl ester (“LM”) pectin or low ester pectin. Most pectin found in fruits and vegetables is HM pectin. Acetate ester groups may further occur at carbon-2 or -3 of the galacturonic acid residues. The degree of acetate esterification (“DAc”) is defined as the percentage of galacturonic acid residues containing an acetate ester group. Most native pectins have a low DAc, one exception being sugar beet pectin. Similarly, the degree of amidation (DA) is defined as the percentage of galacturonic acid residues containing an amide group, and the degree of free acids is calculated as 100−(DE+DA).

In WO 2004005352, Christensen discloses pectin, which is first de-esterified using a biocatalyst and secondly, by chemicals. Such pectins are characterized by having a higher molecular weight than traditional low ester pectin, which lead to gels having higher gel strength than traditional low ester pectin gels.

WO 2005/016027 A1 discloses a process for preparing a food product using depolymerised pectins as stabiliser. Said depolymerised pectins have chains of no greater than 250 units and a viscosity at 25° C. in a 5% solution of 15 cP to 400 cP.

In the field of jams and jellies, low calorie means low soluble solids. Soluble solids are usually sugars such as sucrose and glucose syrups, but can be other compounds such as dextrose, sorbitol or other sugar alcohols, and less digestible compounds such as for instance glycerine and/or polydextrose.

To make a gel having low soluble solids, the literature describes a model that contains different kinds of gums in relatively high concentration. To make gels with pectin, the conditions are important for what kind of pectin gel that will be produced. In high soluble solids, El-Nawawi and Heikal: Factors affecting gelation of high-ester citrus pectin: Process Biochemistry, v. 32, p. 381-385, 1997, describes the conditions as pH from 3.1-3.5 and soluble solids above 65%. The pectin, which forms gels at these conditions, is high ester pectin or high methyl pectin. The gel consists mostly of hydrogen bonds as described by Nielsen and Rolin: Pectin: Polysaccharides, Structural Drivers Functional Versatility 1998, P377-431, and therefore the concentration of soluble solids has to be high, the low water activity preventing the pectin from forming hydrogen bonds to water. Consequently, the hydrogen bonds are formed between pectin and pectin and a gel structure results.

In a system with low concentration of soluble solids, another gelling system has to be introduced. An LM-pectin with DE below 50 does not form gels through hydrogen bonds, but by ionic bonds to calcium ions as discussed by Padival, Ranganna and Manjrekar: Mechanism of gel formation by low methoxyl pectins.: Journal of Food Technology, v. 14, p. 277-287, 1979. For low ester pectin, the gelation takes place in the pH-range 3.0-3.6, and at a concentration of soluble solids above 20%, as described by Rolin and de Vries: Pectin, in Harris (ed), Food Gels: London, Elsevier Applied Science, p. 401-435, 1990.

At lower concentrations of soluble solids, other gums than pectin must be incorporated in order to prevent water from exuding the gel. In Padival, Ranganna and Manjrekar: Mechanism of gel formation by low methoxyl pectins: Journal of Food Technology, v. 14, p. 277-287, 1979 is described a mixture of Locust Been Gum (LBG) and pectin, and the use of kappa carrageenan and locust bean gum together with LM-pectin is described by Soler et al.: Development of formulations for a low-sugar guava preserve using LM pectin and kappa-carrageenan combined with locust bean gum (LBG), published by Phillips, Williams and Wedlock: Wrexham UK, IRL Press. Gums and Stabilisers for the Food Industry 8, 257-266, 1995, describe a mixture of LM-pectin, kappa-carrageenan and LBG. Combinations of pectin and carrageenan are described by Gajar and Badrie: Processing and quality evaluation of a low-calorie christophene jam (Sechium edule (Jacq.) Swartz, Journal of Food Science 67[1], 341-346. 2002. The total concentration of gum, which includes pectin and/or other gums, is as high as 2.03% to prevent syneresis and to achieve a desired texture.

The main taste problem associated with low soluble solids and non-pectin polysaccharides such as locust bean gum, guar gum, starch and carrageenen is the flavour release. Additionally some non-pectin polysaccharides such as locust bean gum, guar gum and starch provide a gummy sensation when eating a jam or jelly containing such polysaccharides. Further non-pectin polysaccharides are less stable than pectin at the low pH values preferred for fruit taste reasons.

There exists a need for making a gelling system based on pectin alone, which is useable in low-calorie jams and jellies. Such jams and jellies are important in order to limit the intake of simple carbohydrates for health reasons and in order to improve the taste and nutritional value by being able to increase the intake of fruit products.

An all pectin gelling system would allow substitution of simple carbohydrates such as sucrose, corn syrup and high fructose syrup with water, intense sweeteners and if desirable complex polysaccharides, while maintaining sensory and application quality.

Additionally, with an all pectin gelling system and a low content of soluble solids, the flavour release is improved.

Further, an all pectin gelling system provides improved stability at low pH values. This means that by using an all pectin gelling system, the manufacturing process, particularly the time and temperature conditions, becomes less critical for achieving the desired gelled and/or spreadable texture of the jam and jelly.

Further, an all pectin gelling system would provide a clean, non-gummy sensation and less syneresis of jams and jellies both in the jar and after the jam or jelly has been mechanically ruptured for instance during use.

Other advantages of an all pectin gelling system include a well-defined yield value or gel formation, which is provided at a temperature just below the filling temperature of the jam or jelly. This provides for an improved distribution of the fruit components; stability and low viscosity of the gelling system at pasteurizing temperatures and pH; minimizing heat spoilage of fruit flavours and fruit colours at the soluble solids in question through an improved heat transmission at pasteurizing temperatures.

It has now surprisingly been found that an all-pectin gelling system is capable of forming gels with less than about 30% soluble solids without exuding unacceptable amounts of water, thus alleviating the need for non-pectin gums to bind water.

### SUMMARY OF THE INVENTION

The present invention relates to a gelling system characterised in that it is a combination of a primary pectin and at least one secondary pectin, wherein said primary pectin has a content of free acids (Degree of Free Acids, DFA) in the range of 50-80% and wherein the combination comprises at least 5% by weight of said secondary pectin, which has a DE in the range of 20-50%.

The present invention also relates to low soluble-solids products incorporating the low soluble-solids products.

Furthermore the invention relates to jam or jelly products comprising the gelling system according to the invention.

The invention is described in more detail with reference to the drawings and the disclosure of preferred embodiments thereof.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 2a shows the gel strength of gels made with different pectins at 7% of soluble solids,

FIG. 2b shows the gel strength of gels made with different pectins at 15% of soluble solids,

FIG. 2c shows the gel strength of gels made with different pectins at 20% of soluble solids,

FIG. 3a shows the syneresis of gels made with different pectins at 7% of soluble solids,

FIG. 3b shows the syneresis of gels made with different pectins at 15% of soluble solids,

FIG. 3c shows the syneresis of gels made with different pectins at 20% of soluble solids, and

FIG. 4 shows syneresis of gels made with different pectins of the same gel strength, but at different use levels.

### DETAILED DESCRIPTION OF THE INVENTION

In a preferred embodiment according to the invention the primary pectin has a content of free acids, DFA, in the range of 55-75%, more particularly in the range of 60-70%. In a preferred embodiment, said primary pectin furthermore has a degree of amidation, DA, in the range of 3-30%, more particularly 10-20%, even more particularly 14-18%. A disclosure of an exemplary primary pectin and the preparation thereof may be found in WO 2004005352. An example of a primary pectin is marketed under the brand name GENU® pectin type X-602-03.

The secondary pectin for use in the gelling system according to the present invention is a conventional amidated or non-amidated pectin having a Degree of Esterification, DE, in the range of 10-75. In a more preferred embodiment said secondary pectin is a low DE pectin, more particularly in the range of 20-50%, even more particularly in the range of 30-40%.

The Degree of Amidation, DA, of said secondary pectin is suitably in the range of 0-30%, more particularly in the range of 5-25%, and especially in the range of 12-18%. Such pectins are commercially available inter alia from CP Kelco, Lille Skensved, Denmark, under the brand names GENU® pectin type 101AS, GENU® pectin type 102AS, GENU® pectin type 104AS, GENU® pectin type LM 12 CG and GENU® pectin type LM 5CS or may be prepared by using conventional pectin preparation procedures.

It has been found that a combination of the above primary and secondary pectins in a ratio of 25-95:5-75 yields excellent gelling properties in low soluble-solids products. Preferred ratios are 50-75:25-50, and a particularly preferred ratio is about 67% of said primary pectin and about 33% of said secondary pectin. Such combinations yield the optimum characteristics in terms of break strength and syneresis as shown in the Examples below.

The gelling system according to the invention is particularly well-suited for low soluble-solids products, particularly products having soluble-solids contents (% SS) in the range of 5-30%, more particularly in the range of 7-20%. Low soluble solids are much sought after today for health reasons. Through the gelling system according to the invention it has been made possible to obtain jams or jellies having adequate break strength while maintaining a low level of syneresis.

Furthermore the gelling system according to the present invention achieves the desired level of break strength at considerably lower use levels than the prior art non-all-pectin gelling systems. Thus, a use level in the range of 0.3-1.1. % by weight is envisaged. More particularly a use level in the range 0.5-0.9 is envisaged, particularly a use level in the range of 0.6-0.8.

Without being bound by theory, the degree of free acids (DFA) in the primary pectin component is believed to be the important feature, because the degree of free acids in pectin determines the number of sites to which divalent cations such as calcium ions may bind two strands of pectin molecules together into a three-dimensional network—a gel. However, if the degree of free acids becomes too big, the interaction between strands of pectin molecules and divalent cations becomes so strong, that the resulting three dimensional network is unable to withhold the aqueous phase inside the three dimensional network. This results in exudation of water, which is traditionally referred to as syneresis.

Materials and Methods

Determination of Degree of Esterification (DE), Amidation (DA) and galacturonic acid (GA) in pectin:

Principle: This method is a modification of the FAO/WHO method for determination of % DE, % DA and % GA in pectin (FCC, Food Chemicals Codex (1996). Committee on Food Chemicals Codex/Food and Nutrition Board, Institute of Medicine, National Academy of Sciences, 4^{th} edition, National Academy Press, Washington D.C., USA.

Materials: Magnetic stirrer, IKA-Werke RO-10 Power, Bie & Berntsen A/S Avedøre, Denmark

Acid alcohol: 100 ml 60% IPA+5 ml fuming 37% HCl, Prolabo, VWR International Aps, Albertslund, Denmark

Autotitrator, Metrohm, 730 Sample Changer, 2600 Glostrup, Denmark

Dosing dispenser: 685 Dosimat, Metrohm, 2600 Glostrup, Denmark

0.1 N NaOH, Prolabo, VWR International Aps, Albertslund, Denmark

0.1 N HCl, Bie & Berntsen A/S Avedøre, Denmark

0.5 N NaOH, Bie & Berntsen A/S Avedøre, Denmark

0.5 N HCL Bie & Berntsen A/S Avedøre, Denmark

Distilling apparatus: Kjeltec™ 2200, Foss, Denmark

Boric Acid 4% with indicator, Bie & Berntsen A/S Avedøre, Denmark

32.5% NaOH for determining N, Bie & Berntsen A/S Avedøre, Denmark

Procedure-Determination of % DE, % DA and % GA:

1. Weigh 2,000 g of pectin in a 250 ml glass beaker.

2. Add 100 ml of acid alcohol and stir on a magnetic stirrer for 10 min.

3. Filtrate through a dried, weighed glass filter crucible (size 1)

4. Rinse the beaker completely with 6×15 ml acid alcohol.

5. Wash with 60% IPA until the filtrate is chloride-free* (approximately 500 ml).

6. Wash with 20 ml of 100% IPA.

7. Dry the sample for two hours at 105° C.

8. Weigh the crucible after drying and cooling in a desiccator.

9. Weigh precisely approximately 0.2000 g of the sample in a 120 ml plastic test tube.

10. Weigh two samples for double determination.

11. Wet the pectin with approximately 2 ml of 100% IPA and add approximately 50 ml of carbon dioxide-free, de-ionized water while stirring on a magnetic stirrer for at least 10 minutes.

12. Three blind testes are prepared. Each 120 ml plastic test tube containing 50 ml of carbon dioxide-free, de-ionized water.

*(Chloride test: Transfer approximately 10 ml of filtrate to a test tube, add approximately 3 ml 3 N HNO₃, and add a few drops of AgN0₃. The filtrate will be chloride-free if the solution is clear, otherwise there will be a precipitation of silver chloride).

Following the acid wash the samples are ready for titration.

The autotitrator is programmed as follows:

1. Titration with 0.1 N NaOH until the equivalence point is reached (pH is approximately 8.5). The titration volume is expressed as V₁

2. 10 ml 0.5 N NaOH is added

3. Mixture stands for 15 minutes

4. 10 ml 0.5 N HCl is added

5. Titration with 0.1 N NaOH until the equivalence point is reached (pH is approximately 8.5). The titration volume used is expressed as V₂ for samples and B₁ for blind tests.

For non-amidated pectin, % DE and % GA is calculated. As follows:

Vₜ=V₁+(V₂−B₁)

% DE (Degree of esterification)=((V₂−B₁)×100)/Vₜ

% DFA (Degree of Free Acid)=100−% DE

% GA*(Degree of Galacturonic Acid)=(194.1×Vₜ×N×100)/200

*On ash- and moisture-free basis

194.1: Molecular weight (g/mol) of Galacturonic Acid

N: Corrected normality for 0.1 N NaOH used for titration (e.g. 0.1002N)

200: Weight in mg of washed and dried sample for titration

% Pure pectin=acid washed and dried amount of pectin×100/weighed amount of pectin

For amidated pectin, distillation of amide groups is now carried out on the Kjeltec using the following protocol:
1. Transfer quantitatively the sample to the destruction tube by rinsing the beaker with a total of 50 ml carbon dioxide-free water in three steps.
2. Place the receiving flask, containing 10.00 ml 4% Boric Acid with indicator in the apparatus.
3. The Kjeltec is programmed to add 30 ml 32.5% NaOH to the destruction tube holding the sample.
4. Set the distillation time at 4 minutes and 40 seconds.
5. Titrate the distillate on the autotitrator with 0.1 N HCl until the equivalence point is reached (pH around 4.8). The titration volume is expressed as V₃.

The blind test sample is distilled and titrated as the sample. The titration volume is expressed as B₂

Vₜ=V₁+(V₂−B₁)+(V₃−B₂)

% DE (Degree of esterification)=((V₂−B₁)×100)/Vₜ

% DA (Degree of amidation)=((V₃−B₂)×100)/Vₜ

% DFA (Degree of Free Acid)=100−% DE−% DA

% GA*(Degree of Galacturonic Acid)=(194.1×Vₜ×N×100)/200

*On ash- and moisture-free basis

194.1: Molecular weight (g/mol) of Galacturonic Acid

N: Corrected normality for 0.1 N NaOH used for titration (e.g. 0.1002 N)

200: Weight in mg of washed and dried sample for titration

% Pure pectin=acid washed and dried amount of pectin×100/weighed amount of pectin.

Rheological measurements of synthetic raspberry gels

Materials:

Mixer and blade: Silverson L4RT with disintegrating head (d=3.5 cm), Silverson Machines Limited, Waterside, Chesham, HP5 IPQ Bucks, England

Electric hot plate: Buch & Holm A/S, DK-2730 Herlev, Denmark.

Electric blade stirrer: RW 20, Janke & Kunkel, IKA-Werk, Bie & Berntsen A/S, Rødovre, Denmark.

Balance: Mettler PJ 6000, Mettler Instruments, Greifensee-Zurich, Switzerland.

Water bath: Haake EK-Julabo MD.

4 crystallizing glasses, diameter: 70 mm, height: 40 mm. Clear pressure-sensitive adhesive tape.

Wooden rack for syneresis measurement

Filter (mesh size 180 mμ and diameter 95 mm)

Plastic funnel (diameter 95 mm)

10 mL measuring glass

TA-XT2 Texture Analyser, Stable Micro Systems, GU71YL Surrey, England.

Sour Raspberry Juice: Sur Hindbœr Saft made by Rynkeby Foods A/S, Ringe 5750, Denmark

Table Sugar

Sodium Benzoate 20% w/v

Potassium Sorbate 20% w/v

Citric Acid 50% w/v

Method: Synthetic raspberry gels are prepared as disclosed in the Examples. Immediately after the preparation thereof, the weight (1000 g) and temperature (95° C.) of the solution is checked before filling into four crystallizing glasses, which are left in a water bath at 20° C. for 24 hours, after which the syneresis and gel strength are measured. SS % (±1%) and pH (3.1-3.3) are checked. Syneresis is measured by turning the gel out on a filter (mesh size 180 mμ and diameter 95 mm) and collecting the released liquid over two hours.

The gel strength, which is defined as the load required to depress the gel by 4 mm, is measured on a TA-XT2 equipped with a one inch plunger. Other settings include:

Pre-test speed: 2.0 mm/s

Test speed: 0.5 mm/s

Post speed: 10.00 mm/s

Rupture test speed: 1 mm/s

Distance: 24.0 mm/s

Force: 40 g

Time: 0.09 s

Count: 5

Type: Auto

Trigger force: 0.5 g

The invention will now be described in more detail with respect to the following, specific, non-limiting examples.

The following pectins were utilized in the synthetic raspberry gels described below.

TABLE 1

| | | | | | Viscosity at 25° C.* |
|---|---|---|---|---|---|
| Pectin | % DE | % DA | % DFA | Mw | of 5% solution |
| A | 32.77 | 14.87 | 52.36 | 163050 | 5000 cP |
| B | 24.56 | 20.51 | 54.93 | 145900 | 3500 cP |
| C | 30.69 | 0 | 69.31 | 83550 | 32500 cP |
| D | 9.63 | 0 | 90.37 | 84850 | 550 cP |
| E | 13.78 | 21.64 | 64.58 | 116900 | 26500 cP |

Pectin A, B, C and D are commercial pectins manufactured by CP Kelco ApS and used for making reduced jams and jellies commercialised under the brand names GENU® pectin type 101AS, GENU® pectin type 104AS, GENU® pectin type LM 12 CG, GENU® pectin type LM 5CS, and GENU® pectin type X-602-03, respectively. Pectin A and B are amidated low ester pectins, while C and D are non-amidated low ester pectins. Pectin E corresponds to an amidated low-ester pectin as disclosed in WO 2004005352 and marketed under the brand name GENU® pectin type X-602-03.

The viscosity was measured as follows:

25.00 gram of stabiliser was dissolved in about 500 ml of demineralised water at 80° C. in a tared beaker in order to prepare a 5% solution. The stabiliser solution was then cooled to 25° C. and pH was adjusted to 3.5±0.2 by adding 1 N hydrochloric acid or 20% sodium carbonate solution. The total weight of the solution was brought to 500.0 gram by diluting with demineralised water. The viscosity was measured on a Brookfield Viscometer model DV-II with spindle No 61 (Spindles No 62 or 63 in case of higher viscosities) at 25° C. at 60 rpm.

Preparation of Synthetic Raspberry Gels

Synthetic raspberry gels of the following compositions were prepared.

TABLE 2
Distribution of Soluble Solids (% SS):

| | 7.5% SS | | | 15.5% SS | | | 20.5% SS | | |
|---|---|---|---|---|---|---|---|---|---|
| Ingredients | g/L | % SS | g SS | g/L | % SS | g SS | g/L | % SS | g SS |
| Sour Raspberry | 300 | 10 | 30 | 300 | 10 | 30 | 300 | 10 | 30 |
| Juice | | | | | | | | | |
| Sugar | 34 | 100 | 34 | 114 | 100 | 114 | 164 | 100 | 164 |
| Pectin | 7.4 | 100 | 7.4 | 7.4 | 100 | 7.4 | 7.4 | 100 | 7.4 |
| Sodium Benzoate | 2 | 20 | 0.4 | 2 | 20 | 0.4 | 2 | 20 | 0.4 |
| (20% w/v) | | | | | | | | | |
| Potassium Sorbate | 2 | 20 | 0.4 | 2 | 20 | 0.4 | 2 | 20 | 0.4 |
| (20% w/v) | | | | | | | | | |
| Citric Acid (50% w/v) | 6 | 50 | 3 | 6 | 50 | 3 | 6 | 50 | 3 |
| Total | | 7.5 | 75.2 | | 15.5 | 155.2 | | 20.5 | 205.2 |

Pectin is dispersed in 200 g of hot water at 90° C. while stirring with Silverson L4RT for 5 min at 5000 rpm. 300 g sour raspberry juice, sugar according to the desired concentration of soluble solids and de-ionized water are mixed to make 500 g. This mixture is heated in a 1 litre pot to the boiling point while stirring at 500 rpm on an electric blade stirrer. Once all sugar is dissolved and the mixture is boiling the hot pectin solution is added, and the solution is held at the boiling point for 2 minutes while stirring. The solution is adjusted to 1000 g with hot de-ionized water before adding 2 ml of sodium benzoate (20% w/v) and 2 ml of potassium sorbate (20% w/v). Finally, 6 ml of citric acid (50% w/v) is added. While adding the preservatives and acid, the solution is held at 95° C. with stirring.

The gel strength and the level of syneresis of the above pectins are measured as described above.

TABLE 3
Gel strength and syneresis of gels

| | Gel strength, grams | | | Syneresis, ml. | | |
|---|---|---|---|---|---|---|
| Pectin | 7% SS | 15% SS | 20% SS | 7% SS | 15% SS | 20% SS |
| A*¹ | 3 | 2.9 | 3.3 | no gel | no gel | no gel |
| B*¹ | 9.1 | 12.2 | 15.7 | 1.4 | 0.8 | 0.5 |
| C*¹ | 3.2 | 3.2 | 3.3 | no gel | no gel | no gel |
| D*¹ | 3 | 3.9 | 3.9 | no gel | no gel | no gel |
| E*¹ | 62 | 83.5 | 122.2 | 2.8 | 1.5 | 2.3 |
| F*² | 40.8 | 57.2 | 69.4 | 3.4 | 2.6 | 1.6 |

*¹prior art pectin.
*²gelling system according to the invention comprising a combination of 33% pectin A and 67% Pectin E.

Pectin A, C and D provide no gelling, and thus, syneresis cannot be determined. When the gel strength is below 5 g. the gel is too weak to provide any visible structure.

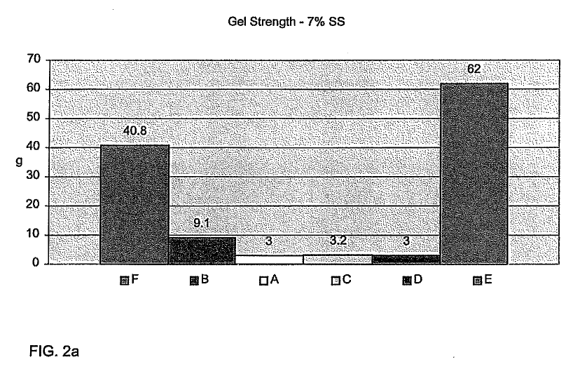

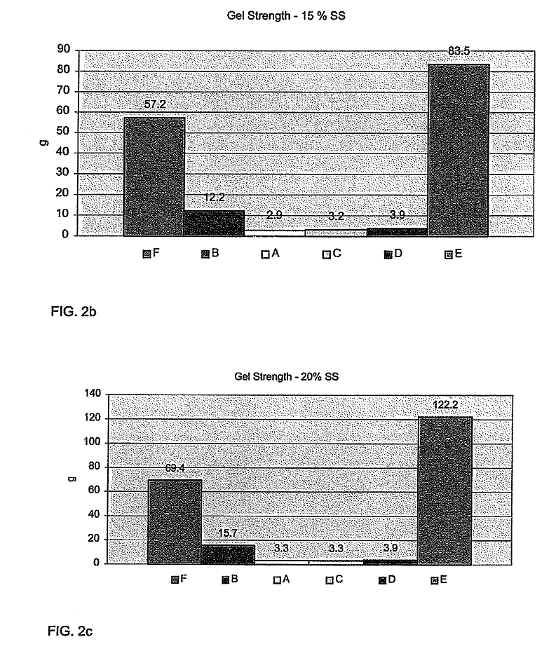

FIG. 2 shows that Pectin E by far provides the highest gel strength. In fact, this gel strength is too high, which means that the resulting gel is too stiff and too hard and brittle. Pectin B provides for a much weaker gel. In fact, this gel strength is too weak to provide an acceptable gel. It also shows that Pectin A, C and D do not form gels.

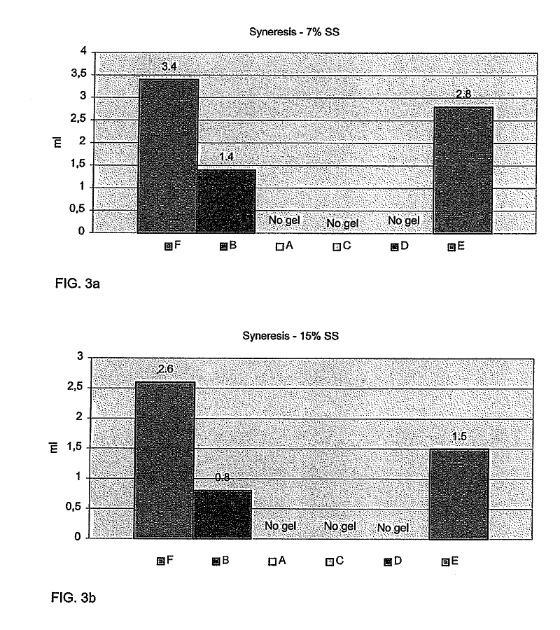

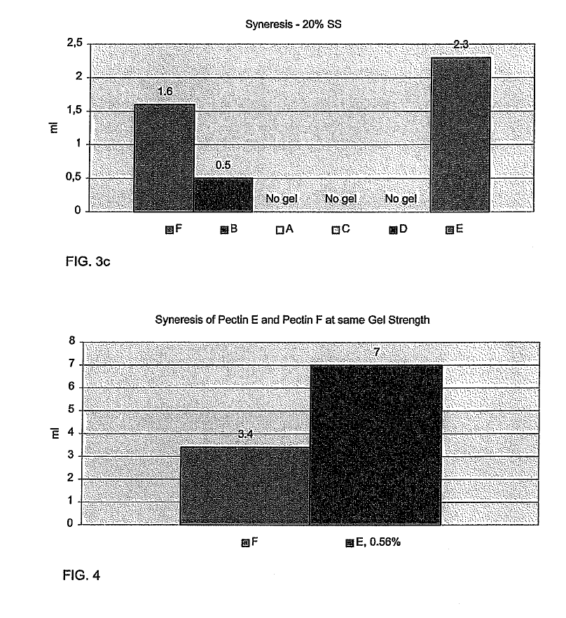

FIG. 3 shows that both Pectin B and Pectin E display syneresis, Pectin B being the one, which produces the lowest amount of syneresis. Thus, the prior art pectins are either too strong or too weak.

However, the combination gelling system F according to the invention provides for a gel strength, which is sensorially acceptable. It is sufficient to provide the needed spreadability without flowing. In addition, the syneresis level is low enough to ensure that the gel remains visibly dry and does not result in visible water while the gel remains in its container, for instance a glass jar.

TABLE 4
Comparison of Pectin E and Pectin F

| | Gel Strength, g | Syneresis, ml |
|---|---|---|
| Pectin type | 7% SS | 7% SS |
| F at 0.73% use level | 40.8 | 3.4 |
| E at 0.56% use level | 42.8 | 7 |

Table 3 showed that Pectin E produced a gel strength, which was organoleptically unacceptable. This gel strength can be reduced to a level corresponding to the gel strength of the Pectin F according to the invention by reducing the concentration of Pectin E to 0.56%. However, at this concentration level the resulting gel is characterised by too much syneresis. The difference in syneresis is shown in FIG. 4.

We claim:

1. A gelling system characterised in that it is a combination of a primary pectin and at least one secondary pectin, wherein said primary pectin has a content of free acids (Degree of Free Acids, DFA) in the range of 50-80% and wherein said combination comprises at least 5% by weight of said secondary pectin having a DE in the range of 20-50%.

2. The gelling system according to claim 1, wherein said primary pectin has a DFA in the range of 55-75%.

3. The gelling system according to claim 1, wherein the DFA of said primary pectin is in the range of 60-70%.

4. The gelling system according to claim 1, wherein said primary pectin has a degree of amidation, DA, in the range of 3-30%.

5. The gelling system according to claim 4, wherein the DA of said primary pectin is in the range of 10-20%.

6. The gelling system according to claim 4, wherein the DA of said primary pectin is in the range of 14-18%.

7. The gelling system according to claim 6, wherein the DE of said secondary pectin is in the range of 30-40%.

8. The gelling system according to claim 1, wherein said secondary pectin has a Degree of Amidation, DA, in the range of 0-30%.

9. The gelling system according to claim 8, wherein the DA of said secondary pectin is in the range of 5-25%.

10. The gelling system according to claim 9, wherein the DA of said secondary pectin is in the range of 12-18%.

11. The gelling system according to claim 1, comprising about 25-95% of said primary pectin and about 5-75% of said secondary pectin.

12. The gelling system according to claim 1 comprising about 50-75% of said primary pectin and about 25-50% of said secondary pectin.

13. The gelling system according to claim 1 comprising about 67% of said primary pectin and about 33% of said secondary pectin.

14. A low soluble-solids product comprising the gelling system according to claim 1.

15. The low soluble-solids product according to claim 14 having a soluble-solids content in the range of 5-30%.

16. The low soluble-solids product according to claim 14 having a soluble-solids content in the range of 7-20%.

17. A jam or jelly product comprising a gelling system according to claim 1.

18. A jam or jelly product comprising about 0.3-1.1% by weight of the gelling system according to claim 1.

19. A jam or jelly product comprising about 0.5-0.9% by weight of the gelling system according to claim 1.

20. A jam or jelly product comprising about 0.6-0.8% by weight of the gelling system according to claim 1.
